(19) United States
(12) Patent Application Publication
(10) Pub. No.: US 2014/0244245 A1
(43) Pub. Date: Aug. 28, 2014

(54) METHOD FOR SOUNDPROOFING AN AUDIO SIGNAL BY AN ALGORITHM WITH A VARIABLE SPECTRAL GAIN AND A DYNAMICALLY MODULATABLE HARDNESS

(71) Applicant: PARROT, Paris (FR)

(72) Inventor: Alexandre Briot, Paris (FR)

(73) Assignee: PARROT, Paris (FR)

(21) Appl. No.: 14/190,859

(22) Filed: Feb. 26, 2014

(30) Foreign Application Priority Data
Feb. 28, 2013 (FR) 1351760

(51) Int. Cl. G10L 21/0224; G10L 21/0208

(52) U.S. Cl. CPC G10L 21/0224; G10L 21/0208; G10L 2021/02087
USPC 704/211

(57) ABSTRACT

The method comprises, in the frequency domain: estimating (18), for each frequency band of the spectrum (Y(k,l)) of each current time frame (y(k)), a speech presence probability in the signal (p(k,l)); calculating (16) a spectral gain (G_{OMLSA}(k,l)), proper to each frequency band of each current time frame, as a function i) of an estimation of the noise energy in each frequency band, ii) of the speech presence probability estimated at step c1), and iii) of a scalar minimal gain value; and selectively reducing the noise (14) by applying the calculated gain at each frequency band. The scalar minimal gain value, representative of a parameter of soundproofing hardness, is a value (Gₘᵢₙ(k)) that can be dynamically modulated at each successive time frame, calculated for the current time frame as a function of a global variable linked to this current time frame with application of an increment/decrement to a parameterized nominal value (Gₘᵢₙ) of the minimal gain.

The invention relates to speech processing in noisy environment.

In particular, it relates to the processing of speech signals picked up by phone devices of the “hands-free” type, intended to be used in a noisy environment.

Such apparatuses includes one or several microphones picking up not only the voice of the user, but also the surrounding noise, which noise constitutes a disturbing element that, in some cases, can go as far as to make the words of the speaker unintelligible. The same goes if it is desired to implement voice recognition techniques, because it is very difficult to operate shape recognition on words embedded in high level of noise.

This difficulty linked to the surrounding noises is particularly restricting in the case of “hands-free” devices for automotive vehicles, whether they are systems incorporated to the vehicle or accessories in the form of a removable box integrating all the signal processing components and functions for the phone communication.

Indeed, the great distance between the microphone (placed at the dashboard or in an upper angle of the passenger compartment roof) and the speaker (whose remoteness is constrained by the driving position) leads to the picking up of a relatively low speech level with respect to the surrounding noise, which makes it difficult to extract the useful signal embedded in the noise. In addition to the permanent stationary component of rolling noise, the very noisy environment typical of automotive vehicles has non-stationary spectral characteristics, i.e. characteristics that evolve unpredictably as a function of the driving conditions: rolling on uneven or cobbled road surfaces, car radio in operation, etc.

Comparable difficulties exist when the device is an audio headset, of the combined microphone/headset type, used for communication functions such as “hands-free” phone functions, in supplement of the listening of an audio source (music for example) coming from an apparatus to which the headset is plugged.

In this case, the matter is to provide a sufficient intelligibility of the signal picked up by the microphone, i.e. the speech signal of the nearby speaker (the headset wearer). Now, the headset may be used in a noisy environment (metro, busy street, train, etc.), so that the microphone picks up not only the speech of the headset wearer, but also the surrounding spurious noises. The wearer is protected from this noise by the headset, in particular if it is a model with closed earphones, isolating the ear from the outside, and even more if the headset is provided with an “active noise control” function. But the remote speaker (who is at the other end of the communication channel) will suffer from the spurious noises picked up by the microphone and superimposing onto and interfering with the speech signal of the nearby speaker (the headset wearer). In particular, certain formants of the speech that are essential to the understanding of the voice are often embedded in noise components commonly encountered in the usual environments.

The invention more particularly relates to the techniques of single-channel selective soundproofing, i.e. operating on a single signal (in contrast to the techniques implementing several microphones, whose signals are judiciously combined and are subjected to a spatial or spectral coherence analysis, for example by techniques of the beamforming type or others). However, it will apply with the same pertinence to a signal recomposed from several microphones by a beamforming technique, insofar as the present invention applies to a scalar signal.

In the present case, the matter is to operate the selective soundproofing of a noisy audio signal, generally obtained after digitization of the signal collected by a single microphone of the phone equipment.

The invention more particularly aims at an improvement added to the algorithms of noise reduction based on a signal processing in the frequency domain (hence after application of a Fourier transform, FFT) consisting in applying a spectral gain calculated as a function of several speech presence probability estimators.

More precisely, the signal y coming from the microphone is cut into frames of fixed length, overlapping each other or not, and each frame of index k is transposed to the frequency domain by FFT. The resulting frequency signal Y(k,l), which is also discrete, is then described by a set of frequency “bins” (frequency bands) of index l, typically 128 positive frequency bins. For each signal frame, a number of estimators are updated to determine a frequency probability of speech presence p(k,l). If the probability is high, the signal is considered as a useful signal (speech) and is thus preserved with a spectral gain G(k,l)=1 for the considered bin. In the contrary case, if the probability is low, the signal is classed as noise and thus reduced, or even suppressed, by application of a spectral attenuation gain far lower than 1.

In other words, the principle of this algorithm consists in calculating and applying to the useful signal a “frequency mask” that preserves the useful information of the speech signal and eliminates the spurious noise signal. Such technique may in particular be implemented by an algorithm of the OM-LSA (Optimally Modified—Log Spectral Amplitude) type, such as those described by:
[1] I. Cohen and B. Berdugo, “Speech Enhancement for Non-Stationary Noise Environments”, Signal Processing, Vol. 81, No 11, pp. 2403-2418, November 2001; and
[2] I. Cohen, “Optimal Speech Enhancement Under Signal Presence Uncertainty Using Log-Spectral Amplitude Estimator”, IEEE Signal Processing Letters, Vol. 9, No 4, pp. 113-116, April 2002.

The U.S. Pat. No. 7,454,010 B1 also describes a comparable algorithm taking into account, for calculating the spectral gains, information of presence or not of the voice in a current time segment.

Reference may also be made to the WO 2007/099222 A1 (Parrot), which describes a soundproofing technique implementing a calculation of speech presence probability.

The efficiency of such a technique lies of course in the model of the speech presence probability estimator intended to discriminate speech and noise.

In practice, the implementation of such an algorithm comes up against a number of defects, the two main of which are the “musical noise” and the appearance of a “robotic voice”.

“Musical noise” is characterized by a non-uniform residual background noise carpet, favoring certain specific frequencies. The noise tone is then no longer natural, which makes the listening disturbing. This phenomenon results from the fact that the frequency soundproofing processing is operated without dependence between neighbor frequencies at the time of frequency discrimination between speech and noise, because the processing integrates no mechanism for preventing from two very different neighbor spectral gains. Now, in periods of noise alone, a uniform attenuation gain would be ideally required to preserve the noise tone; but in practice, if the spectral gains are not homogeneous, the residual noise becomes “musical” with the appearance of frequency notes at the less-attenuated frequencies, corresponding to bins wrongly detected as containing useful signal. It will be noted that this phenomenon is all the more marked as the application of high attenuation gains is authorized.

The “robotic voice” or “metallic voice” phenomenon occurs when it is chosen to operate a very aggressive noise reduction, with high spectral attenuation gains. In presence of speech, frequencies corresponding to speech but wrongly detected as being noise will be highly attenuated, making the voice less natural, or even fully artificial (“robotization” of the voice).

Parameterizing such an algorithm thus consists is finding a compromise on the soundproofing aggressiveness, so as to eliminate a maximum of noise without the undesirable effects of the application of too high spectral attenuation gains become too perceptible. However, the latter criterion proves to be extremely subjective and, on a relatively large panel of users, it proves to be difficult to find a compromise adjustment that can be approved unanimously.

To minimize such defects, inherent to a technique of soundproofing by application of a spectral gain, the “OM-LSA” model provides the fixation of a lower limit Gₘᵢₙ for the attenuation gain (expressed in a logarithmic scale, this attenuation gain thus corresponds hereinafter to a negative value) applied to the areas identified as noise, so as to prevent from too much soundproofing, to limit the appearance of the above-mentioned defects. However, this solution is not optimal: of course, it contributes to eliminate the undesirable effects of an excessive noise reduction, but in the same time it limits the soundproofing performance.

The problem of the invention is to compensate for this limitation, by making the system of noise reduction by application of a spectral gain (typically according to an OM-LSA model) more efficient, while respecting the above-mentioned constraints, i.e. efficiently reducing the noise without altering the natural aspect of the voice (in presence of speech) or that of the noise (in presence of noise). In other words, it is advisable to make the undesirable effects of the algorithmic processing imperceptible by the remote speaker, while strongly attenuating the noise.

The basic idea of the invention consists in modulating the calculation of the spectral gain G_{OMLSA}—calculated in the frequency domain for each bin—by a global indicator, observed at the time frame and no longer at a single frequency bin.

This modulation will be operated by a direct transformation of the lower limit Gₘᵢₙ of the attenuation gain—which limit is a scalar commonly referred to as “soundproofing hardness”—into a time function whose value will be determined as a function of a time descriptor (or “global variable”) reflected by the state of the various estimators of the algorithm. These latter will be chosen as a function their pertinence to describe known situations for which it is known that the choice of the soundproofing hardness Gₘᵢₙ can be optimized.

Thereafter and according to the cases, the time modulation applied to this logarithmic attenuation gain Gₘᵢₙ can correspond either to an increment or to a decrement: a decrement is associated with a greater hardness of noise reduction (higher logarithmic gain in absolute value), conversely, an increment of this negative logarithmic gain is associated with a smaller absolute value and thus a lower hardness of noise reduction.

Indeed, it can be noticed that an observation at the scale of the frame may often make it possible to correct certain defects of the algorithm, in particular in very noisy areas where it may sometimes wrongly detect a noise frequency as being a speech frequency: hence, if a frame of noise alone is detected (at the frame), it will be possible to perform a more aggressive soundproofing without thereby introducing musical noise, thanks to a more homogeneous soundproofing.

Conversely, over a period of noisy speech, it will be possible to less soundproof so as to perfectly preserve the voice while making sure that the variation of energy of the residual background noise is not perceptible. We have thus a double lever (hardness and homogeneity) to module the strength of the soundproofing according to the case considered—phase of noise alone or phase of speech—, the discrimination between either cases resulting from an observation at the scale of the time frame:
in a first embodiment, the optimization will consist in modulating in the suitable direction the value of the soundproofing hardness Gₘᵢₙ so as better reduce the noise in phase of noise alone, and to better preserve the voice in phase of speech;

More precisely, the invention proposes a method for soundproofing an audio signal by application of an algorithm with a variable spectral gain, function of a speech presence probability, including in a manner known per se the following successive steps:
a) generating successive time frames of the digitized noisy audio signal;
b) applying a Fourier transform to the frames generated at step a), so as to produce for each signal time frame a signal spectrum with a plurality of predetermined frequency bands;
c) in the frequency domain:
   c1) estimating, for each frequency band of each current time frame, a speech presence probability;
   c3) calculating a spectral gain, proper to each frequency band of each current time frame, as a function of: i) an estimation of the noise energy in each frequency band, ii) the speech presence probability estimated at step c1), and iii) a scalar minimal gain value representative of a soundproofing hardness parameter;
   c4) selectively reducing the noise by applying at each frequency band the gain calculated at step c3);
d) applying an inverse Fourier transform to the signal spectrum consisted of the frequency bands produced at step c4), so as to deliver for each spectrum a time frame of soundproofed signal; and
e) reconstructing a soundproofed audio signal from the time frames delivered at step d).

Characteristically of the invention:
said scalar minimal gain value is a value that can be dynamically modulated at each successive time frame; and
the method further includes, before step c3) of calculating the spectral gain, a step of:
   c2) calculating, for the current time frame, said modulatable value as a function of a global value observed at the current time frame for all the frequency bands; and
said calculation of step c2) comprises applying, for the current time frame, an increment/decrement added to a parameterized nominal value of said minimal gain.

In a first implementation of the invention, the global variable is a signal-to-noise ratio of the current time frame, evaluated in the time domain. The scalar minimal gain value may in particular be calculated at step c2) by application of the relation:

Gₘᵢₙ(k)=Gₘᵢₙ+ΔGₘᵢₙ(SNR_{y}(k))

k being the index of the current time frame,
Gₘᵢₙ(k) being the minimal gain to be applied to the current time frame,
Gₘᵢₙ being said parameterized nominal value of the minimal gain,
ΔGₘᵢₙ (k) being said increment/decrement added to Gₘᵢₙ, and
SNR_{y} (k) being the signal-to-noise radio of the current time frame.

In a second implementation of the invention, the global variable is an average speech probability, evaluated at the current time frame.

The scalar minimal gain value may in particular be calculated at step c2) by application of the relation:

Gₘᵢₙ(k)=Gₘᵢₙ+(P_{speech}(k)−1)·Δ₁Gₘᵢₙ+P_{speech}(k)·Δ₂Gₘᵢₙ

k being the index of the current time frame,
Gₘᵢₙ(k) being the minimal gain to be applied to the current time frame,
Gₘᵢₙ being said parameterized nominal value of the minimal gain,
P_{speech}(k) being the average speech probability evaluated at the current time frame,
Δ₁Gₘᵢₙ being said increment/decrement added to Gₘᵢₙ in phase of noise, and
Δ₂Gₘᵢₙ being said increment/decrement added to Gₘᵢₙ in phase of speech.

The average speech probability may in particular be evaluated at the current time frame by application of the relation:

$${P}_{speech} ( k ) = \frac{1}{N} {\sum }_{l}^{N} p ( k , l )$$

l being the index of the frequency band,
N being the number of frequency bands in the spectrum, and
p(k,l) being the speech presence probability in the frequency band of index l of the current time frame.

In a third implementation of the invention, the global variable is a Boolean signal of detection of voice activity for the current time frame, evaluated in the time domain by analysis of the time frame and/or by means of an external detector.

The scalar minimal gain value may in particular be calculated at step c2) by application of the relation:

Gₘᵢₙ(k)=Gₘᵢₙ+VAD(k)·ΔGₘᵢₙ

k being the index of the current time frame,
Gₘᵢₙ(k) being the minimal gain to be applied to the current time frame,
Gₘᵢₙ being said parameterized nominal value of the minimal gain,
VAD (k) being the value of the Boolean signal of detection of voice activity of the current time frame, and
ΔGₘᵢₙ being said increment/decrement added to Gₘᵢₙ.

An exemplary embodiment of the device of the invention will now be described, with reference to the appended drawings in which same reference numbers designate identical or functionally similar elements throughout the figures.

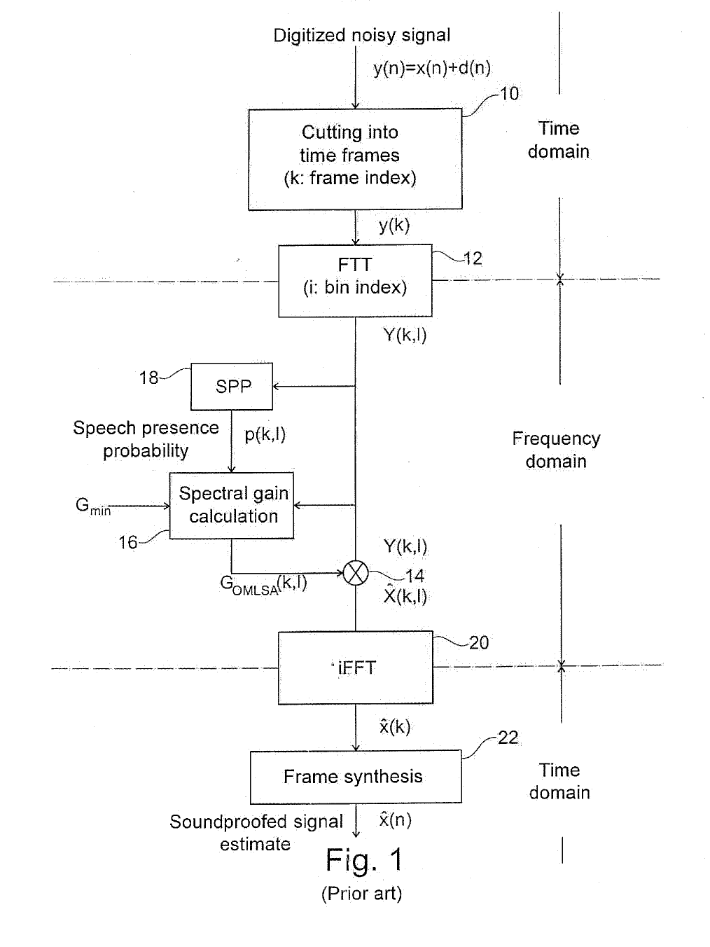

FIG. 1 schematically illustrates, as a functional block diagram, the way a soundproofing processing of the OM-LSA type according to the prior art is implemented.

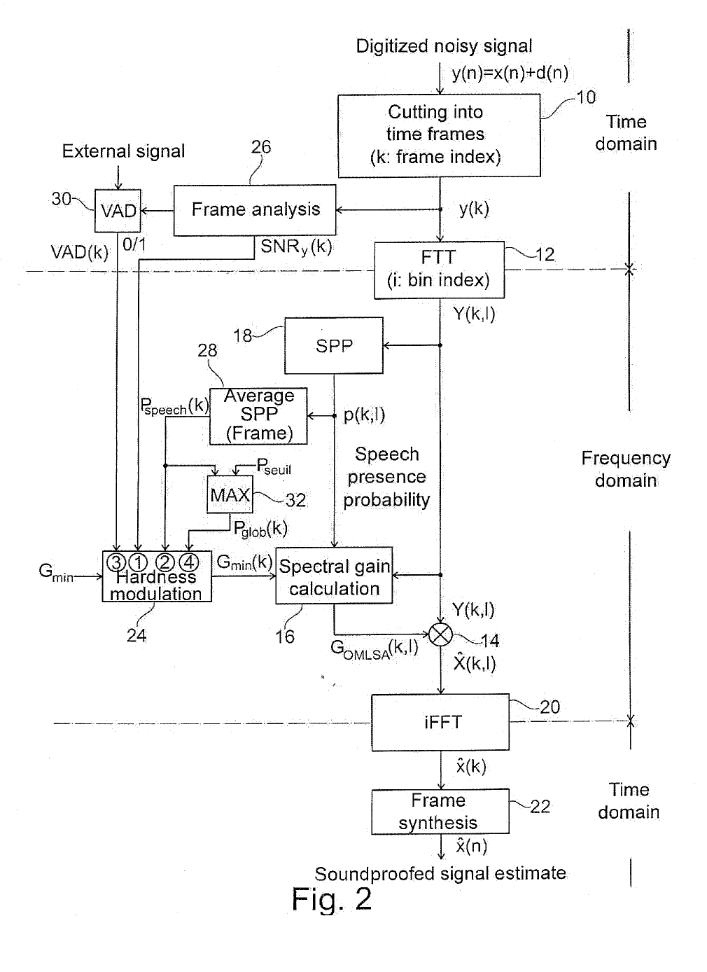

FIG. 2 illustrates the improvement provided by the invention to the soundproofing technique of FIG. 1.

The process of the invention is implemented by software means, schematized in the figures by a number of functional blocks corresponding to suitable algorithms performed by a microcontroller or a digital signal processor. Although, for the clarity of the disclosure, the different functions are presented as separate modules, they implement common elements and correspond in practice to a plurality of functions wholly performed by a same software.

### OM-LSA Soundproofing Algorithm According to the Prior Art

FIG. 1 schematically illustrates, as a functional block diagram, the way a soundproofing processing of the OM-LSA type according to the prior art is implemented.

The digitized signal y(n)=x(n)+d(n) comprising a speech component x(n) and a noise component d(n) (n being the sample rank) is cut (block 10) into segments or time frames y(k) (k being the frame index) of fixed length, overlapping or not, usually frames of 256 samples for a signal sampled at 8 kHz (narrow-band telephone switchboard).

Each time frame of index k is then transposed to the frequency domain by a fast Fourier transform FFT (block 12): the resulting signal obtained or spectrum Y(k,l), also discrete, is then described by a set of frequency bands or frequency “bins” (l being the bin index), for example 128 positive frequency bins. A spectral gain G=G_{OMLSA}(k,l), proper to each bin, is applied (block 14) to the frequency signal Y(k,l), to give a signal \hat{X}(k,l):

\hat{X}(k,l)=G_{OMLSA}(k,l)·Y(k,l)

The spectral gain G_{OMLSA}(k,l) is calculated (block 16) as a function, on the one hand, of a speech presence probability p(k,l), that is a frequency probability evaluated (block 18) for each bin, and on the other hand, of a parameter Gₘᵢₙ, that is a scalar minimal gain value, commonly referred to “soundproofing hardness”. This parameter Gₘᵢₙ fixes a lower limit of the attenuation gain applied to the areas identified as noise, so as to avoid that the phenomena of musical noise and robotic voice become too marked due to the application of too high and/or heterogeneous spectral attenuation gains.

The calculated spectral gain G_{OMLSA}(k,l) is of the form:

G_{OMLSA}(k,l)={G(k,l)}^{p(k,l)}·Gₘᵢₙ^{1-p(k,l)}

The calculation of the spectral gain and that of the speech presence probability are thus advantageously implemented as an algorithm of the OM-LSA (Optimally Modified-Log Spectral Amplitude) type, as that described in the (above-mentioned) article:
[2] I. Cohen, “Optimal Speech Enhancement Under Signal Presence Uncertainty Using Log-Spectral Amplitude Estimator”, IEEE Signal Processing Letters, Vol. 9, No 4, pp. 113-116, April 2002.

Essentially, the application of gain referred to as “LSA (Log-Spectral Amplitude) gain” makes it possible to minimize the average quadratic distance between the logarithm of the amplitude of the estimated signal and the logarithm of the amplitude of the original speech signal. This criterion reveals to be adapted, because the distance chosen is in better adequacy with the behavior of the human ear and thus gives better results in a qualitative point of view.

In all the cases, the matter is to reduce the energy of the very noisy frequency components by applying thereto a low gain, while leaving unchanged (by application of a gain equal to 1) those which are a little noisy or not noisy at all.

The “OM-LSA” (Optimally-Modified LSA) algorithm improves the calculation of the LSA gain by weighting it by the conditional speech presence probability or SPP p(k,l), for the calculation of the final gain: the noise reduction applied is all the higher (i.e. the gain applied is all the lower) as the speech presence probability is low.

The speech presence probability p(k,l) is a parameter that can take several different values between 0 and 100%. This parameter is calculated according to a technique known per se, examples of which are notably disclosed in:
[3] I. Cohen and B. Berdugo, “Two-Channel Signal Detection and Speech Enhancement Based on the Transient Beam-to-Reference Ratio”, IEEE International Conference on Acoustics, Speech and Signal Processing ICASSP 2003, Hong-Kong, pp. 233-236, April 2003.

As often in this field, the described method has not for objective to identify precisely on which frequency components of which frames the speech is absent, but rather to give a confidence index between 0 and 1, a value 1 indicating that the speech is definitely absent (according to the algorithm) whereas a value 0 states the contrary. By its nature, this index is assimilated to the speech absence probability a priori, i.e. the probability that the speech is absent on a given frequency component of the considered frame. It is of course a non-rigorous assimilation, in that even if the presence of the speech is probabilistic ex ante, the signal picked up by the microphone has at each instant only one of two distinct states: at the considered instant, it can either include speech or not. In practice, this assimilation gives however good results, which justify the use thereof.

Reference can also be made to WO 2007/099222 A1 (Parrot), which describes in detail a soundproofing technique derived from this principle, implementing a calculation of speech presence probability.

The resulting signal \hat{X}(k,l)=G_{OMLSA}(k,l). Y(k,l), i.e. the useful signal Y(k,l) to which has been applied the frequency mask G_{OMLSA}(k,l), is thereafter subjected to an inversed Fourier transform iFFT (block 20), to go back from the frequency domain to the time domain. The time frames obtained are then grouped together (block 22) to give a digitized soundproofed signal \hat{x}(n).

### OM-LSA Soundproofing Algorithm According to the Invention

FIG. 2 illustrates the modifications brought to the just-exposed algorithm. The blocks having the same reference numbers correspond to functions identical or similar to those disclosed above, just as the references of the various signals processed.

In the known implementation of FIG. 1, the scalar value Gₘᵢₙ of the minimal gain representative of the soundproofing hardness was chosen more or less empirically, in a such a manner that the degradation of the voice remains a little audible, while ensuring a acceptable attenuation of the noise.

As exposed in introduction, it is however desirable to perform a more aggressive soundproofing in phase of noise alone, but without thereby introducing a musical noise; conversely, over a period of noisy speech, it may be possible to less soundproof so as to perfectly preserve the voice while making sure that the variation of energy of the residual background noise is not perceptible.

There may be, according to the case (phase of noise alone or phase of speech), a double interest in modulating the soundproofing hardness: the latter will be modulated by dynamically varying the scalar value of Gₘᵢₙ, in the suitable direction that will reduce the noise in phase of noise alone and that will better preserve the voice in phase of speech.

For that purpose, the scalar value Gₘᵢₙ, initially constant, is transformed (block 24) into a time function Gₘᵢₙ(k) whose value will be determined as a function of the global variable (also referred to as “time descriptor”), i.e. a variable considered as globally at the frame and not at the frequency bin.

This global variable may be reflected by the state of one or several different estimators already calculated by the algorithm, which will be chosen according to the case as a function of their relevance.

Those estimators may in particular be: i) a signal-to-noise ratio, ii) an average speech presence probability and/or iii) a detection of voice activity. In all these examples, the soundproofing hardness Gₘᵢₙ becomes a time function Gₘᵢₙ(k) defined by the estimators, which are time estimators, making it possible to describe known situations for which it is desired to modulate the value of Gₘᵢₙ so as to influence the reduction of noise by dynamically modifying the signal soundproofing/degradation compromise.

By the way, it will be noted that, in order for this dynamic modulation of the hardness not to be perceptible by the listener, a mechanism should be provided to prevent from abrupt variations of Gₘᵢₙ(k), for example by a conventional technique of time smoothing. It will hence be avoided that abrupt time variations of the hardness Gₘᵢₙ(k) become audible on the residual noise, which is very often stationary in the case, for example, of a driver in rolling condition.

### Time Descriptor: Signal-to-Noise Ratio

The starting point of this first implementation is the observation that a speech signal picked up in a silent environment has only a little, or even no, need to be soundproofed, and that a powerful soundproofing applied to such a signal would lead rapidly to audible artefacts, without the comfort of listening is improved from the single point of view of the residual noise. Conversely, an excessively noisy signal may rapidly become unintelligible or cause a progressive strain on listening; in such a case, the benefit of a significant soundproofing will be indisputable, even at the cost of audible degradation (nevertheless reasonable and controlled) of the speech.

In other words, the noise reduction will be all the more beneficial for the understanding of the useful signal as the non-processed signal is noisy. This may be taken into account by modulating the hardness parameter Gₘᵢₙ as a function of the signal-to-noise ratio a priori or of the current noise level of the processed signal:

Gₘᵢₙ(k)=Gₘᵢₙ+ΔGₘᵢₙ(SNR_{y}(k))

Gₘᵢₙ(k) being the minimal gain to be applied to the current time frame,
Gₘᵢₙ being a parameterized nominal value of this minimal gain,
ΔGₘᵢₙ(k) being the increment/decrement added to the value Gₘᵢₙ, and
SNR_{y}(k) being the signal-to-noise ratio of the current frame, evaluated in the time domain (block 26), corresponding to the variable applied at the input no \textcircled{1} of the block 24 (such “inputs” being symbolic and having only a value of illustration of the various alternative possibilities of implementation of the invention).

### Time Descriptor: Average Speech Presence Probability

Another pertinent criterion for modulating the hardness of the reduction may be the presence of speech for the time frame considered.

With the conventional algorithm, when it is attempted to increase the soundproofing hardness Gₘᵢₙ, the phenomenon of “robotic voice” appears before that of “musical noise”. Hence, it seems possible and interesting to apply a greater soundproofing hardness in a phase of noise alone, by modulating simply the soundproofing hardness parameter by a global indicator of speech presence: in period of noise alone, the residual noise—at the origin of the listening strain—will be reduced by application of a greater hardness, and that without counterpart because the hardness in phase of speech can remain unchanged.

As the algorithm of noise reduction is based on a calculation of frequency speech presence probability, it is easy to obtain an average index of speech presence at the scale of the frame based on the various frequency probabilities, so as to differentiate the frames mainly consisted of noise from those that contain useful speech. It is for example possible to use the conventional estimator:

$${P}_{speech} ( k ) = \frac{1}{N} {\sum }_{l}^{N} p ( k , l )$$

P_{speech}(k) being the average speech probability evaluated at the current time frame,
N being the number of bins of the spectrum, and
p(k,l) being the speech presence probability of the bin of index l of the current time frame.

This variable P_{speech}(k) is calculated by the block 28 and applied at the input no \textcircled{2} of the block 24, which calculates the soundproofing hardness to be applied for a given frame:

Gₘᵢₙ(k)=Gₘᵢₙ+(P_{speech}(k)−1)·Δ₁Gₘᵢₙ+P_{speech}(k)·Δ₂Gₘᵢₙ

Gₘᵢₙ(k) being the minimal gain to be applied to the current time frame,
Gₘᵢₙ being a parameterized nominal value of this minimal gain, and
Δ₁Gₘᵢₙ being an increment/decrement added to Gₘᵢₙ in phase of noise, and
Δ₂Gₘᵢₙ being an increment/decrement added to Gₘᵢₙ in phase of speech.

The above expression highlights well the two complementary effects of the presented optimization, i.e.:
the increase of the hardness of the noise reduction by a factor Δ₁Gₘᵢₙ in phase of noise so as to reduce the residual noise, typically Δ₁>0, for example Δ₁=+6 dB; and
the reduction of the hardness of the noise reduction by a factor Δ₂Gₘᵢₙ in phase of speech so as to better preserve the voice, typically Δ₂<0, for example Δ₂=−3 dB.

### Time Descriptor: Voice Activity Detector

In this third implementation, a voice activity detector or VAD (block 30) is advantageously used to perform the same type of hardness modulation as in the previous example. Such a “perfect” detector delivers a binary signal (absence vs. presence of speech), and is distinguishable from the systems that deliver only a speech presence probability varying between 0 and 100% in a continuous way or by successive steps, which may introduce significant false detections in noisy environments.

The voice activity detection module taking only two distinct values ‘0’ or ‘1’, le modulation of the soundproofing hardness will be discrete:

Gₘᵢₙ(k)=Gₘᵢₙ+VAD(k)·ΔGₘᵢₙ

Gₘᵢₙ(k) being the minimal gain to be applied to the current time frame,
Gₘᵢₙ being a parameterized nominal value of said minimal gain,
VAD (k) being the value of the Boolean signal of voice activity detection for the current time frame, evaluated in the time domain (block 30) and applied to the input no \textcircled{3} of the block 24, and
ΔGₘᵢₙ being the increment/decrement added to the value Gₘᵢₙ.

The voice activity detector 30 may be made of different manners, three examples of implementation of which will be given hereinafter.

In a first example, the detection is operated based on the signal y(k), in a manner that is intrinsic to the signal picked up by the microphone; an analysis of the more or less harmonic character of this signal makes it possible to determine the presence of a voice activity, because a signal having a high harmonicity may be considered, with a low margin of error, as being a voice signal, hence corresponding to a presence of speech.

In a second example, the voice activity detector 30 operates in response to the signal produced by a camera, installed for example in the passenger compartment of a motor vehicle and oriented so that its angle of view includes in any circumstance the head of the driver, considered as the nearby speaker. The signal delivered by the camera is analyzed to determine, based on the movement of the mouth and the lips, if the speaker is speaking or not, as described among others in the EP 2 530 672 A1 (Parrot SA), to which reference may be made for more explanations. The advantage of this technique of image analysis is to have complementary information fully independent of the acoustic noise environment.

A third example of sensor that can be used for the voice activity detection is a physiological sensor liable to detect certain voice vibrations of the speaker that are not or a little corrupted by the surrounding noise. Such a sensor may notably be consisted of an accelerometer or a piezoelectric sensor applied against the cheek or the temple of the speaker. It may be in particular incorporated to the ear pad of a headphone of a combined microphone/headset unit, as described in the EP 2 518 724 A1 (Parrot SA), to which reference may be made for more details.

Indeed, when a person emits a voiced sound (i.e. a speech component whose production is accompanied by a vibration of the vocal cords), a vibration propagates from the vocal cords to the pharynx and to the oro-nasal cavity, where it is modulated, amplified and articulated. The mouth, the soft palate, the pharynx, the sinus and the nasal fossa then serve as a resonating chamber for this voiced sound, and their walls being elastic, they also vibrate and these vibrations are transmitted by internal bone conduction and are perceptible at the cheek and the temple.

Those vibrations at the cheek and the temple have the characteristic to be, by nature, very little corrupted by the surrounding noise. Indeed, in the presence of external noises, even significant, the tissues of the cheek and of the temple hardly vibrate, and that whatever the spectral composition of the external noise. A physiological sensor that collects these voice vibrations devoid of noise gives a signal representative of the presence or the absence of voiced sounds emitted by the speaker, thus making it possible to very well discriminate the phases of speech and the phases of silence of the speaker.

### Variant of Implementation of the OM-LSA Soundproofing Algorithm

As a variant or in addition of what is explained above, the spectral gain G_{OMLSA}—calculated in the frequency domain for each bin may be indirectly modulated, by weighting the frequency speech presence probability p(k,l) by a global time indicator observed at the frame (and no longer at a simple particular frequency bin).

In this case, if a frame of noise alone is detected, it may advantageously be considered that each frequency speech probability should be null, and the local frequency probability could be weighted by a global data, wherein such global data makes it possible to make a deduction on the real case encountered at the scale of the frame (phase of speech/phase of noise alone), which the only data in the frequency domain does not allow to formulate; in the presence of noise alone, the situation can be reduced to a uniform soundproofing, avoiding any musicality of the noise, which will keep its original “grain”.

In other words, the initially frequency-domain speech presence probability will be weighted by a global speech presence probability at the scale of the frame: it is then tried to homogeneously soundproof the whole frame in case of absence of speech (uniform soundproofing when the speech is absent).

Indeed, as disclosed above, the speech presence probability P_{speech}(k) (calculated as the arithmetic average of the frequency speech presence probabilities) is a rather liable indicator of the presence of speech at the scale of the frame. It may then be contemplated to modify the conventional expression of calculation of the OM-LSA gain, i.e.:

G_{OMLSA}(k,l)={G(k,l)}^{p(k,l)}·Gₘᵢₙ^{1-p(k,l)}

by weighting the frequency speech presence probability by a global data of speech presence p_{glob}(k) evaluated at the frame:

G_{OMLSA}(k,l)={G(k,l)}^{p(k,l)·p}^{_{glob}}^{(k)}·Gₘᵢₙ^{1-p(k,l)·p}^{_{glob}}^{(k)}

G_{OMLSA}(k,l) being the spectral gain to be applied to the bin of index/of the current time frame,
G(k,l) being a suboptimal soundproofing gain to be applied to the bin of index l,
p(k,l) being the speech presence probability of the bin of index l of the current time frame,
p_{glob}(k) being the global and thresholded speech probability, evaluated at the current time frame, and
Gₘᵢₙ being a parameterized nominal value of the spectral gain.

The global data p_{glob}(k) at the time frame may notably be evaluated as follows:

$${p}_{glob} ( k ) = \frac{1}{{P}_{seuil}} \cdot max \{ {P}_{speech} ( k ) ; {P}_{seuil} \}$$

$${P}_{speech} ( k ) = \frac{1}{N} {\sum }_{l}^{N} p ( k , l )$$

Pₛₑᵤᵢₗ being a threshold value of the global speech probability, and
N being the number of bins in the spectrum.

This amounts to replace in the conventional expression the frequency probability p(k,l) by a combined probability p_{combinée}(k,l) that includes a weighting by the non-frequency global data p_{glob}(k), evaluated at the time frame in the presence of speech:

G_{OMLSA}(k,l)={G(k,l)}^{p}^{_{combinée}}^{(k,l)}·Gₘᵢₙ^{1-p}^{_{combinée}}^{(k,l)}p_{combinée}(k,l)=p(k,l)·p_{glob}(k)

In other words:
in the presence of speech at the frame, i.e. if P_{speech}(k)>Pₛₑᵤᵢₗ, the conventional expression of the OM-LSA gain calculation remains unchanged;
in the absence of speech at the frame, i.e. if P_{speech}(k)<Pₛₑᵤᵢₗ, the frequency probabilities p(k,l) will on the contrary be weighted by the low global probability p_{glob}(k), which will have for effect to make the probabilities uniform by reducing the values thereof;
in the particular asymptotic case P_{speech}(k)=0, all the probabilities will be null and the soundproofing will be fully uniform.

The evaluation of the global data p_{glob}(k) is schematized in FIG. 2 by the block 32, that receives as an input the data Pₛₑᵤᵢₗ (parameterizable threshold value) and P_{speech}(k,l) (value itself calculated by the block 28, as described above), and delivers as an output the value p_{glob}(k) that is applied at the input \textcircled{4} of the block 24.

Here again, a global data calculated at the frame is used to refine the calculation of the frequency soundproofing gain, and this as a function of the case encountered (absence/presence of speech). In particular, the global data makes it possible to estimate the real situation encountered at the scale of the frame (phase of speech vs. phase of noise alone), which the only frequency data would not allow to formulate. In the presence of noise alone, the situation can be reduced to a uniform soundproofing, which is an ideal solution as the residual noise perceived will then never be musical.

### Results Obtained by the Algorithm of the Invention

As exposed just above, the invention is based on the highlighting of the fact that the signal soundproofing/degradation compromise is based on a calculation of spectral gain (function of a scalar minimal gain parameter and of a speech presence probability) whose model is sub-optimal, and proposes a formula involving a time modulation of such elements of spectral gain calculation, which become a function of pertinent time descriptors of the noisy speech signal.

The invention is based on the exploitation of a global data to process in a more pertinent and more adapted manner each frequency band, the soundproofing hardness being made variable as a function of the presence of speech on a frame (a greater soundproofing is made when the risk of having a counterpart is low).

In the conventional OM-LSA algorithm, each frequency band is processed independently, and for a given frequency, the knowledge a priori of the other bands is not integrated. Now, a wider analysis that observes the whole of the frame to calculate a global indicator characteristic of the frame (herein, a speech presence indicator capable of discriminating even coarsely phases of noise alone and phases of speech) is a useful and efficient means for refining the processing at the scale of the frequency band.

Concretely, in a conventional OM-LSA algorithm, the soundproofing gain is generally adjusted to a compromise value, typically of the order of 14 dB.

The implementation of the invention makes it possible to adjust this gain dynamically to a value varying between 8 dB (in presence of speech) and 17 dB (in presence of noise alone). The reduction of noise is therefore far more powerful, and makes the noise almost imperceptible (and in any case not musical) in the absence of speech in the major part of the situations commonly encountered. And even in the presence of speech, the soundproofing does not modify the tone of the voice, whose rendering remains natural.

1. A method for soundproofing an audio signal by application of an algorithm with a variable spectral gain, function of a speech presence probability, including the following successive steps:
a) generating (10) successive time frames (y(k)) of the digitized noisy audio signal (y(n));
b) applying a Fourier transform (12) to the frames generated at step a), so as to produce for each signal time frame a signal spectrum (Y(k,l)) with a plurality of predetermined frequency bands;
c) in the frequency domain:
c1) estimating (18), for each frequency band of each current time frame, a speech presence probability (p(k,l));
c3) calculating (16) a spectral gain (G_{OMLSA}(k,l)), proper to each frequency band of each current time frame, as a function of: i) an estimation of the noise energy in each frequency band, ii) the speech presence probability estimated at step c1), and iii) a scalar minimal gain value (Gₘᵢₙ) representative of a soundproofing hardness parameter;
c4) selectively reducing the noise (14) by applying at each frequency band the gain calculated at step c3);
d) applying an inverse Fourier transform (20) to the signal spectrum (\hat{X}(k,l) consisted of the frequency bands produced at step c4), so as to deliver for each spectrum a time frame of soundproofed signal; and
e) reconstructing (22) a soundproofed audio signal from the time frames delivered at step d).
the method being characterized in that:
said scalar minimal gain value (Gₘᵢₙ) is a value (Gₘᵢₙ(k)) that can be dynamically modulated at each successive time frame (y(k)); and
the method further includes, before step c3) of calculating the spectral gain, a step of:
c2) calculating (24), for the current time frame (y(k)), said modulatable value (y(k)) as a function of a global value (SNR_{y} (k); P_{speech}(k); VAD (k)) observed at the current time frame for all the frequency bands; and
said calculation of step c2) comprises applying, for the current time frame, an increment/decrement (ΔGₘᵢₙ (k); Δ₁Gₘᵢₙ, Δ₂Gₘᵢₙ; ΔGₘᵢₙ) added to a parameterized nominal value (Gₘᵢₙ) of said minimal gain.

2. The method of claim 1, wherein said global variable is a signal-to-noise ratio (SNR_{y} (k)) of the current time frame, evaluated (26) in the time domain.

3. The method of claim 2, wherein said the scalar minimal gain value is calculated at step c2) by application of the relation:
Gₘᵢₙ(k)=Gₘᵢₙ+ΔGₘᵢₙ(SNR_{y}(k))
k being the index of the current time frame,
Gₘᵢₙ(k) being the minimal gain to be applied to the current time frame,
Gₘᵢₙ being said parameterized nominal value of the minimal gain,
ΔGₘᵢₙ (k) being said increment/decrement added to Gₘᵢₙ, and
SNR_{y} (k) being the signal-to-noise ratio of the current time frame.

4. The method of claim 1, wherein said global variable is an average speech probability (P_{speech}(k)), evaluated (28) at the current time frame.

5. The method of claim 4, wherein the scalar minimal gain value is calculated at step c2) by application of the relation:
Gₘᵢₙ(k)=Gₘᵢₙ+(P_{speech}(k)−1)·Δ₁Gₘᵢₙ+P_{speech}(k)·Δ₂Gₘᵢₙ
k being the index of the current time frame,
Gₘᵢₙ(k) being the minimal gain to be applied to the current time frame,
Gₘᵢₙ being said parameterized nominal value of the minimal gain,
P_{speech}(k) being the average speech probability evaluated at the current time frame,
Δ₁Gₘᵢₙ being said increment/decrement added to Gₘᵢₙ in phase of noise, and
Δ₂Gₘᵢₙ being said increment/decrement added to Gₘᵢₙ in phase of speech.

6. The method of claim 4, wherein the average speech probability is evaluated at the current time frame by application of the relation:
$${P}_{speech} ( k ) = \frac{1}{N} {\sum }_{l}^{N} p ( k , l )$$
l being the index of the frequency band,
N being the number of frequency bands in the spectrum, and
p(k,l) being the speech presence probability in the frequency band of index l of the current time frame.

7. The method of claim 1, wherein said global variable is a Boolean signal of detection of voice activity (VAD (k)) for the current time frame, evaluated (30) in the time domain by analysis of the time frame and/or by means of an external detector.

8. The method of claim 7, wherein the scalar minimal gain value is calculated at step c2) by application of the relation:
Gₘᵢₙ(k)=Gₘᵢₙ+VAD(k)·ΔGₘᵢₙ
k being the index of the current time frame,
Gₘᵢₙ(k) being the minimal gain to be applied to the current time frame,
Gₘᵢₙ being said parameterized nominal value of the minimal gain,
VAD (k) being the value of the Boolean signal of detection of voice activity of the current time frame, and
ΔGₘᵢₙ being said increment/decrement added to Gₘᵢₙ.
